(19) United States
(12) Patent Application Publication
(10) Pub. No.: US 2011/0208670 A1
(43) Pub. Date: Aug. 25, 2011

(54) Execution Optimizer

(75) Inventors: Neil S. Joseph, West Hampstead (GB); Kristian West, Long Melford (GB)

(73) Assignee: JPMorgan Chase Bank, N.A., New York, NY (US)

(21) Appl. No.: 12/708,975

(22) Filed: Feb. 19, 2010

(51) Int. Cl. G06Q 40/00; G06N 5/02

(52) U.S. Cl. 705/36 R; 706/47; 705/37

(57) ABSTRACT

Exemplary embodiments of the present invention provide systems and methods for optimizing the automatic execution of trade orders and picking an optimal trading algorithm for said execution. An order may be received and processed using a set of pre-determined screening rules. When at least one of the screening rules is violated, a meta-algorithm may be applied to the order. The meta-algorithm may select an algorithm to automatically execute the order based price slippage to determine if the algorithm is “optimal.”

### FIELD OF THE INVENTION

Embodiments of the invention relate generally to automating execution of trades. More specifically, embodiments are directed to method and system for selecting an algorithm for executing an order, based on metrics to optimize the algorithm selection.

### BACKGROUND OF THE INVENTION

Investment banking covers a range of activities. Such activities include: underwriting, selling, and trading securities (e.g., stocks and bonds), providing financial advisory services such as mergers and acquisition advice, and managing assets. Investment banks offer these services to a variety of clients, both big and small, including, but not limited to, corporations, governments, non-profit institutions, and individuals.

In the trading of securities, investment banking generally involves a buy side and a sell side. On the buy side, an investor or client provides the investment bank with an order. Typically the order is to conduct a transaction relating to securities, such as buying a certain amount of said securities. The order is typically placed with a person, such as a broker or trader, or electronically over a computer network. The investment bank executes the order following receipt thereof. Depending upon various factors, such as size and price, the order can either be executed manually or it can be executed automatically. Either type of execution can occur in an appropriate computer based trading system. A delay in the execution of the order is possible. Such delays impact the order because market conditions are volatile. Changes in the market therefore occur from the time the order is placed to the time that the order is actually executed.

A delay in placing the order can have adverse consequences for the order. For example, the price of the security desired to be purchased can change, either up or down, between the time of order receipt and order execution. This is known as price slippage.

### SUMMARY OF THE INVENTION

An embodiment of the present invention provides a computer-implemented method for optimizing execution of an order. An order is received by a computer processor. Screening rules are applied to the order by a computer processor. At least one screening rule is violated. A meta-algorithm is applied to the order by computer processor when the at least one screening rule is violated. The meta-algorithm selects an algorithm to process the order based on the at least one violated screening rule. The algorithm is selected by the meta-algorithm based upon a historical assessment of price slippage and/or other appropriate factors. The order is executed by a computer processor using the selected algorithm. The price slippage is measured and recorded electronically for use as part of the ongoing historical assessment.

An embodiment of the present invention provides a computer based system for optimizing execution of an order. The system has a network with one or more servers and a workstation with one or more computer processors. The workstation is communicatively coupled to the network and provides an interface to the computer based system. An algorithm module with one or more computer processors is communicatively coupled to the network. The algorithm module receives an order, determines screening rules to apply to the order, applies the screening rules to the order, and applies a meta-algorithm to the order when at least one screening rule is violated. The meta-algorithm selects an algorithm for processing the order. The algorithm is selected based on a historical assessment of price slippage and/or other appropriate factors. The algorithm module records any price slippage at order execution for use as part of the historical assessment. A database is communicatively coupled to the network and has the historical price slippage data, the meta-algorithm and the algorithm included therein.

Advantages of this invention in addition to those described above are apparent from the following detailed description of exemplary embodiments of the invention.

### BRIEF DESCRIPTION OF THE DRAWINGS

FIG. 1 is a flow chart of a method of optimizing the execution of an order in accordance with an exemplary embodiment.

FIG. 2A is a rule tree in accordance with an exemplary embodiment.

FIG. 2B is an example of a rule tree in accordance with an exemplary embodiment.

FIG. 3 is a system for optimizing the execution of an order in accordance with an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF THE PREFERRED EMBODIMENTS

It will be readily understood by those persons skilled in the art that the embodiments of the inventions described herein are capable of broad utility and application. Many embodiments and adaptations of the embodiments of the inventions other than those herein described, as well as many variations, modifications and equivalent arrangements, will be apparent from or reasonably suggested by the embodiments of the inventions and foregoing description thereof, without departing from the substance or scope of the invention.

Accordingly, while the embodiments of the invention have been described herein, in detail in relation to the exemplary embodiments, it is to be understood that this disclosure is illustrative and exemplary of embodiments of the invention and is made to provide an enabling disclosure of the invention. Accordingly, the subsequent disclosure is not intended to be construed to limit the embodiments of the invention or otherwise to exclude any other such embodiments, adaptations, variations, modifications and equivalent arrangements. While the various embodiments of the present invention are described in the context of execution optimization for orders in the context of security trading, the methods and systems described herein may be applied to other related items, such as other types of financial transactions.

Exemplary embodiments of the present invention provide systems and methods for optimizing the automatic execution of orders for securities, including choosing an optimal trading algorithm for order execution. According to exemplary embodiments, price slippage may be used as a metric in determining if an algorithm is “optimal.” It should be appreciated that the use of the term optimal does not necessarily mean that the price slippage is at a minimum or a maximum, but that the price slippage is intended to be reduced relative to historical data, given the characteristics and the environment of the order. It should be appreciated that other metrics may be used in addition to the price slippage for choosing an optimal algorithm.

Application of embodiments of the present invention may be primarily in investment banking. However, one of ordinary skill in the art may appreciate application to other fields that use similar algorithms to automate execution of tasks. The use of the term “investment bank” in the present application is used for illustrative examples, and is not meant to be limiting on the scope of the exemplary embodiments. Furthermore, the use of the term “securities” or “stocks” or “bonds” in the exemplary embodiments is used merely for illustrative examples is not meant in any way to be limiting upon the exemplary embodiments.

According to an exemplary embodiment of the invention, a customer or client and an investment bank may agree upon a set of execution rules to apply to orders for trades. Using such rules, if the investment bank receives an order that satisfies these rules, the order will automatically be executed. The rules may be thought of as screening criteria for the order, serving a gatekeeper function to determine how the processing of the order proceeds within the system. Exemplary rules may include, for example, a price ceiling, a bid-ask ceiling, a share number ceiling, and a historical-average-daily-volume ceiling. For example, orders may be rejected, or at least not be eligible for automatic execution, unless the orders are under 10% of the instrument's last 30-day historical average daily volume. The rules may be programmed into the execution optimizer system according to exemplary embodiments. The rules may be configured as a tree structure. The rules may be applied in a hierarchical manner within the tree structure.

Once the rules have been programmed, a system according to exemplary embodiments may receive an order from a user. The user may be any one of numerous personnel working for and/or associated with the investment bank or similar entity. For example, an order may be received and then input into a system by a portfolio manager or trader for a brokerage house. The order may be for a security. For example, the order may be for a stock or a bond. It should be appreciated that other types of securities may be involved. The order may involve a combination of securities. Once the order is input into the system, the system may analyze the characteristics of the order. The system may apply the rules to the order. If the order meets all the criteria established by the rules, the system may route the order for automatic execution. The system may select an appropriate algorithm to apply to the order. The order may then be automatically executed using the algorithm.

If, on the other hand, an order is received that fails to satisfy at least one rule, then there are several possibilities. Some rules may be immutable, such that if they are not met, then the order is passed out within the system or to another system into a queue for some form of additional action. Such additional action may include manual assessment of the order or manual execution of the order. Failing to fulfill some rules may trigger execution of a meta-algorithm. The meta-algorithm may analyze the order and select an appropriate algorithm to apply to the order. The algorithm may be selected based upon a metric to ensure that the algorithm is appropriate or optimal for order execution. For example, if an order has a bid-ask spread that is too large according to the screening rules, then the order may be routed to the meta-algorithm by the system. The meta-algorithm may then process the order and the meta-algorithm may pick an algorithm that is expressly optimized to handle on trades in which the bid-ask spread is large.

The meta-algorithm may use price slippage and other appropriate factors as a metric in selecting an optimal algorithm. The other appropriate factors may include impact or forecast model prices, as well as other metrics. Price slippage may be defined as the difference between the price at the time of order arrival and the final average execution price, measured in basis points. Alternatively, price slippage may be defined as the difference between the price at the time of order arrival and the asking price at the time of order execution, measured in basis points. The meta-algorithm may be adaptive, in that the meta-algorithm may intelligently track its historical usage, as measured by price slippage, and select the optimal algorithm for the particular requested trade at hand. The price slippage may be calculated by a variety of methods. For example, the price slippage may be based upon average historical price slippage, weighted average historical price slippage, moving average historical price slippage, weighted moving average historical price slippage, exponential weighted moving average historical price slippage, or slippage from the trade forecast. It should be appreciated that the price slippage may be calculated by a combination of methods.

The execution optimizer according to exemplary embodiments allows an investment bank or similar entity, and by extension, its customers and/or clients, to: (a) benefit from the way the investment banks chooses the right algorithm, (b) benefit from getting into the market quicker, and (c) be able to track the effectiveness of each algorithm so the investment bank knows whether they are getting better execution through one algorithm or one trade to another such that they can adjust the rules accordingly, and make sure that the execution is refined over time. Furthermore, exemplary embodiments may use parameters and characteristics that are available to the buy side of an investment bank.

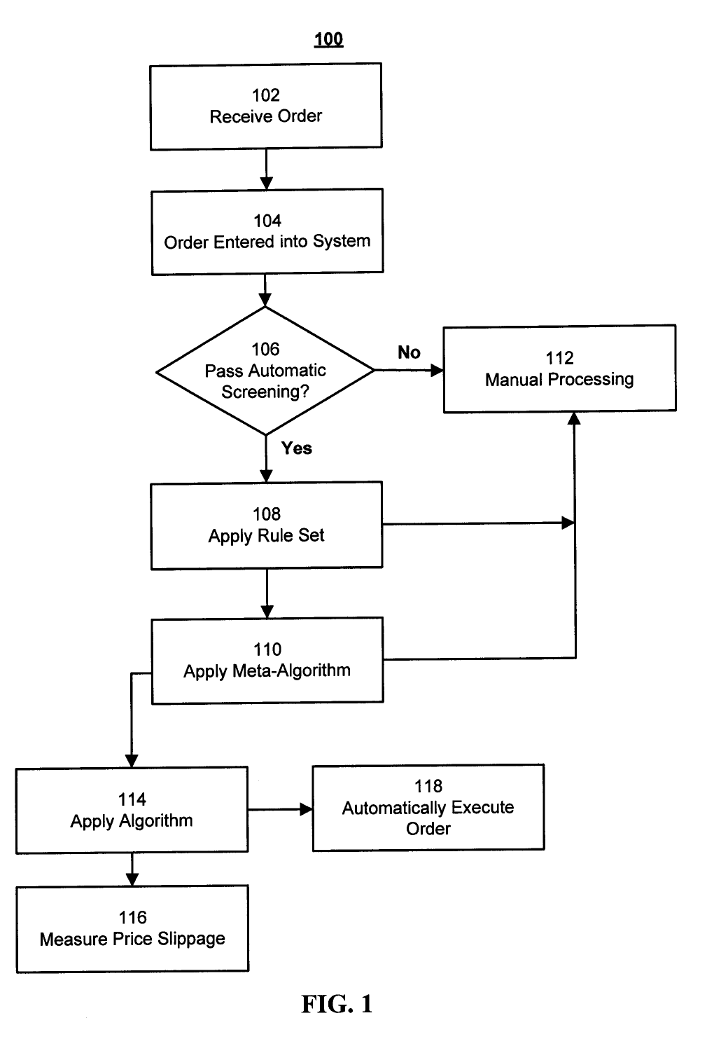

FIG. 1 depicts a flow chart of a method of optimizing the execution of an order according to exemplary embodiments. Exemplary method 100 is provided by way of example, as there are a variety of ways to carry out the methods disclosed herein. The method 100 as shown in FIG. 1 may be executed or otherwise performed by one or a combination of various systems, such as a computer implemented system. Each block shown in FIG. 1 represents one or more processes, methods, and/or subroutines carried out in the exemplary method 100. Each block may have an associated processing machine or the blocks depicted may be carried out through one processor machine. While the exemplary method 100 may use an order from a client for stocks as an example of optimizing an order, the method shown in FIG. 1 may be applied to other types of orders, such as other securities or other types of financial transactions.

While the method of FIG. 1 illustrates certain steps performed in a particular order, it should be understood that the embodiments of the present invention may be practiced by adding one or more steps to the processes, omitting steps within the processes and/or altering the order in which one or more steps are performed.

The method of FIG. 1 may commence with receipt of an order at block 102. The order may be of any type. For example, the order may be for a purchase or transaction relating to one or more securities. The order may be received by an investment bank or other similar type of institution from a client or customer. For example, a client may place an order to purchase $1 million of a particular stock. The order may be received in a number of different ways, such as email, phone, internet, or from a third party representing the client or customer. The order may be conveyed using a combination of such methods. For example, a client may phone an operator to place an order to purchase a given amount of stocks and then send an email adding to the order.

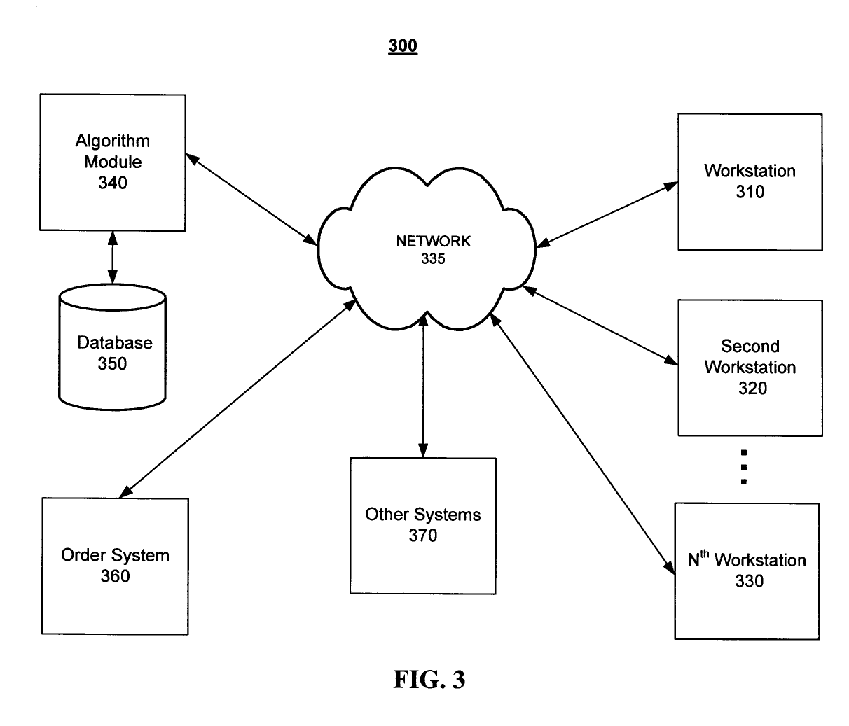

At block 104, the order is entered. The order may be entered into an appropriate system, such as the exemplary system depicted in FIG. 3. The system may be configured to execute the method 100 according to exemplary embodiments. The order may be entered into the system by the person receiving the order from the client. For example, a human receiving the order from the client may enter the order into the system. According to exemplary embodiments, a third party may enter the order. For example, the person receiving the order may contact a third party, perhaps located remote from the person receiving the order, and relay the order to the third party for entry into the system. In certain cases, depending on the method of order receipt, the order may be automatically entered into the system. For example, the client may place an order through an internet site. The order may be directly fed into the system from the internet site without external intervention. It should be appreciated that combinations of both automatic and manual entry for the order are possible.

Further, upon entry of the order into the system, the person or system entering the order may configure certain settings and/or flags relating to the order. In the case of a system entering the order, the certain settings and/or flags may be automatically configured by the system entering the order Such settings and/or flags may determine how the order is processed within the system. For example, a flag may be set on the order which disables autorouting for the order. In such cases, the order may immediately go into an appropriate queue for manual processing. Additionally, an order may have special instructions and/or constraints associated therewith. The special instructions and/or constraints may be entered with the order. Alternatively, the special instructions and/or constraints may be standing rules previously agreed upon and programmed into the system prior to the entry of the order. The special instructions and/or constraints may be applied to all orders associated with or originating from a particular client or customer. For example, a special instruction for all orders from client A may be to disable autorouting. According to exemplary embodiments, only certain types of orders may have the methods described herein applied thereto. For example, the certain types of orders may include: sells, short sells, buy to cover, and buys. Other types of orders, upon entry, may be automatically routed to a manual queue, bypassing the automatic execution system.

Defining criteria relating to the execution of the order may be input with the order entry at block 104. The criteria may serve as additional guidance to the system regarding how the execution of the order may proceed. For example, an alpha value may be selected by the user to apply to the order. The alpha value may be selected from a pre-configured listing of alpha values. Exemplary alpha values may include:
A1—send order straight to market (riskiest);
A2—maximum participation is 25%;
A3—maximum participation is 15%;
A4—maximum participation is 10%;
A5—maximum participation is 5% (least risky).
   The system may have a default alpha value setting that is applied to the order if no alpha value is selected, if the order is a certain type of order from a certain client or customer, or if an alpha value is input that does not correspond to A1 to A5. For example, the default alpha value may be A3. Alpha may be a coefficient which measures risk-adjusted performance, factoring in the risk due to the specific security, rather than the overall market. A high value for alpha implies that the security has performed better than would have been expected given its beta. Beta may be a measure of volatility, or systematic risk, of a security in comparison to the market as a whole. In exemplary embodiments, the alpha may refer to a short term alpha. The short term alpha may be calculated by a fund manager or other similar person. For example, A1 may indicates that the fund manager predicts a far greater short term alpha than A5. The greater the expected short term alpha, the more aggressively the trade may be executed. This may imply the need for a greater participation rate, hence the decreasing participation rate from A1 to A5. Participation rate refers to the volume that is desired for trading in relation to other trades that are being executed in the market at the same time by the same entity. By way of a non-limiting example, A1 through A5 may be defined as follows:
A1—1.15 to 1.20;
A2—1.05 to 1.10;
A3—−1 to 1;
A4—−1.05 to −1.10;
A5—−1.15 to −1.20.

Following entry of the order into the system at block 104, a series of processing checks may be performed on the order. This series of checks may be performed during the automatic execution screening of block 106. These pre-processing checks may include verifying various attributes of the order and may be performed at block 106. For example, the following attributes of the order may be checked:
Approval status;
Disable auto-routing flag;
Initial Public Offering (IPO)/Placement field;
Contract for Difference field;
Confirmed field; and
Special constraint with disable auto-routing set.
   According to exemplary embodiments, if any of these attributes are set, then the order will not be automatically routed. The order may be placed in a queue for manual processing as shown at block 112.

According to exemplary embodiments, as described herein, a series of rules may be applied to the order during the processing thereof. Some rules may be immutable and, as such, these rules must be met for all orders. If an order does not meet an immutable rule, the order may not be automatically executed and the meta-algorithm may not be applied to the order. Consequently, the order may be placed into a queue for further review and manual action, as described herein. Further, at any point in the processing of the order, the automatic execution of an order may be overridden and the order may be passed to manual processing. These immutable rules may be applied as part of the initial screening of the order at block 106.

During the initial automatic screening processing phase for the order at block 106, the system may check the order to determine if the order is a follow-on order. A follow-on order is an order that is related to a previous or prior order that has already been entered and forwarded for automatic execution processing. According to exemplary embodiments, a follow-on order is related to a previous or prior order if it is an order for the same instrument. A related order may be on the same side, such as buy or sell, as the previous order. It may be desirable to amalgamate or aggregate the follow-on order with the prior order to have them merged and executed as a single order. If the determination is made that the order is a follow-on order, then the order may be forwarded with details identifying the original order so that the system may identify the prior order, wherever it may be in the processing chain, and perform an amalgamation by canceling the original order and merging the orders together. For example, the amalgamation may be performed by summing the total number of shares in the order. It should be appreciated that a particular order may have multiple follow-on orders. The system may be configured appropriately to process such multiple follow-on orders. According to exemplary embodiments only buy to cover and buy orders may be amalgamated.

A set of guidance rules may be programmed to provide the system with standing guidance on the handling of follow-on orders. For example, the following rules may be applied:
If both orders (to be amalgamated) are private bank orders or both orders are non-private bank orders, then amalgamate. However, if the orders are not the same (i.e., both are not private bank orders) the orders will not be aggregated and the follow on order will be sent to the execution optimizer as a separate order (if it is an auto-routable order).
If both orders are of the same order type (market/limit), then amalgamate. If not, then the follow on order will be sent to the execution optimizer as a separate order and will not be aggregated (if it is an auto-routable order).

The amalgamation may combine the alpha selection for the orders. For example:
For an amalgamation of one follow on order with the initial order, if both orders have the same shares quantity, the higher alpha from both orders shall be applied to the amalgamated order.
For an amalgamation of one follow on order with the initial order, the new order will assume the alpha level of the order/release with the largest number of shares yet to be executed.
For an amalgamation of two or more follow on orders with an prior order, the weighted average of (shares yet to be executed X alpha) will be used to decide the value of the new order's alpha level (rounded to the nearest whole number).
For no alpha values on orders, alpha values will be applied according to the initial screening of order attributes, such as the order not being auto-routable.

The order may be further assessed to ensure that the order has sufficient details for execution. If the order does not have sufficient details, then the system may place the order into a queue with a flag so that an individual will select and manually continue processing the order, as shown by block 112.

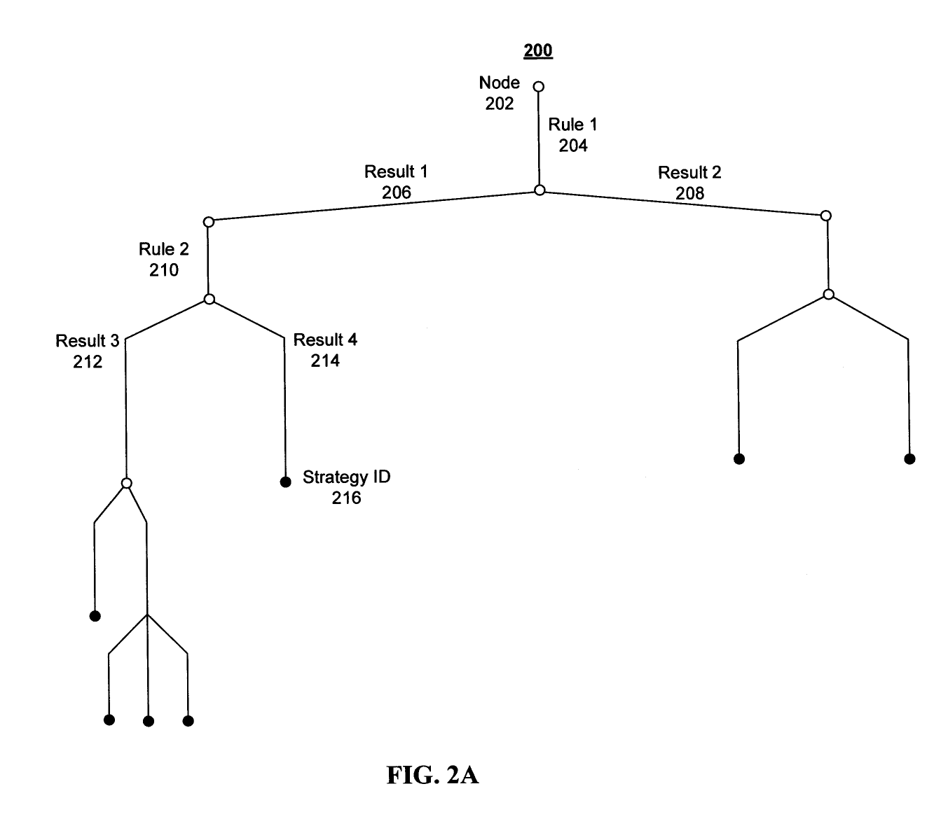

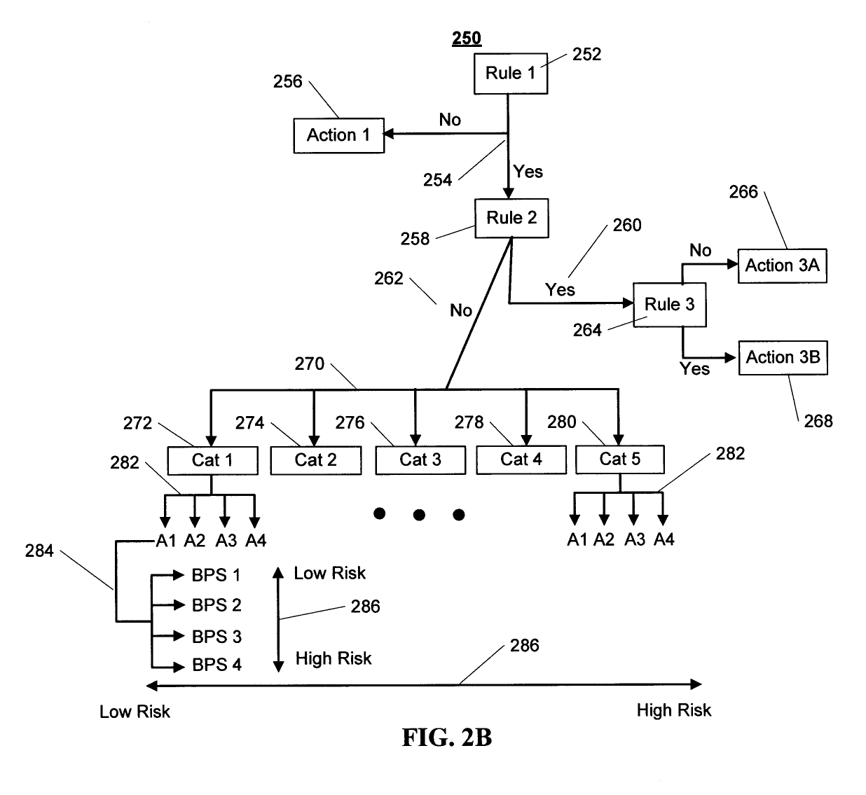

At block 108, a set of criterion or roadblocks are applied to the order. This application may be completed automatically. The set of criterion or roadblocks may be applied to the order to determine if the order may have a meta-algorithm applied at block 110. That is, the set of criteria may be applied to check if the order may be automatically executed or returned for manual execution. Such criteria may be built into a set of rules to apply to the orders input into at block 104. The rules may be configured as a tree structure, by way of a non-limiting example, as shown in FIG. 2A. The criteria may be pre-determined by the client or customer and the investment bank or similar entity, as described above. The rules may be unique to a particular client or set of clients, such that the rules will only be applied to orders from that client or clients. Accordingly, the system may have a multiplicity of rules contained therein. As part of the initial processing of the order, the system may determine the set of rules to apply to the particular order, then apply the set of rules.

Once at block 108, the order may be assessed to verify that the order is within the universe of stocks contained in the system. If the order is outside of that universe, the order may be sent to manual processing at block 112. For example, the rule criterion may read “is the order within the universe of stocks?” If the order does not meet this criterion because the stock is not within the defined universe of stocks, then the system will place the order into a queue with a flag so that an individual will select and manually continue processing the order, as shown by block 112. The universe of stocks for exemplary embodiments may be pre-determined by users of the system. This rule may be an immutable rule as described above.

A set of rules may then be applied to the order. By way of non-limiting example, a set of rules may consist of the following:
if the order is for less than $A million, and
if the order is less than B % of its last C-day historical average daily volume, and
if the order is less than D shares, and
if the order is less than E % of the size of the bid offer spread, and
if the spread is less than F basis points,
   then the order may be automatically executed. Applying exemplary numbers to the variables of the above rule, an exemplary rule set may be:
if the order is for less than $15 million, and
if the order is less than 10% of its last 30-day historical average daily volume, and
if the order is less than 500,000 shares, and
if the order is less than 90% of the size of the bid offer spread, and
if the spread is less than 20 basis points,
   then automatically execute the order. The variable may be defined in certain ranges. By way of non-limiting example, the variables may be defined as follows:
A may be $1 million, $5 million, $10 million, $15 million, $20 million, $50 million, $100 million, etc.;
B may be 1%, 5%, 10%, 15%, 20%, 25%, etc.;
C may be 5 days, 10 days, 15 days, 20 days, 30 days, etc.;
D may be 10,000 shares, 25,000 shares, 50,000 shares, 100,000 shares, 250,000 shares, 500,000 shares, etc.;
E may be 70%, 75%, 80%, 90%, 95%, etc.
   It should be appreciated that other values for the variables and ranges for values for the variables are possible.

At block 110, a meta-algorithm is applied to the order. If the order fails to meet each of the criteria applied at block 108, the order may still be routed to block 108 and the meta-algorithm may be applied to the order. The meta-algorithm may be an algorithm for selecting another algorithm or ruleset. For example, following on the ruleset example from block 108 above, if the order is for greater than $15 million, then the order will fail that rule but the meta-algorithm may be applied to the order. It should be appreciated that the order may fail a rule at block 108 and be routed to block 112 for manual processing. Failure of certain rules within a ruleset may require manual processing instead of application of the meta-algorithm. For example, certain rules at block 108 may be immutable as described above.

The meta-algorithm may verify the time of the order to assess if financial market data is available for application to the order. The hours for individual financial markets may be programmed into the meta-algorithm and other rulesets according to exemplary embodiments. For example, the following rules may be applied to the order relating to market data:
If there is no market data available, the order may be sent to the manual queue.
If the order is sent before a market opens, and there is no market data for the best bid and offer, then an attempt to use the previous day's closing data may be made.
If there is no closing price data, then send the order may be sent to the manual queue.
If the order is sent during continuous trading and there is no market data for the Best Bid and Offer, then use:
   (a) last traded price and if the last traded price is not available, then attempt to use
   (b) the opening price and if the opening price is not available, then attempt to use
   (c) Previous day's close.
If neither (a) (b) or (c) is available, then send the order to the manual queue.

According to exemplary embodiments, the meta-algorithm may be configured to analyze why the order failed a particular criteria in its selection of an appropriate algorithm or algorithms. The appropriate algorithm may be one, or multiple algorithms, that will capture the failed criteria to the maximum extent possible to allow automatic execution of the order. The algorithm selection may be updated and reoptimized over the life of order based on an assessment of the performance of the market. This reoptimization may be conducted based upon real time data from the market. The meta-algorithm may be configured to select such an algorithm based on a metric or metrics. The metric may ensure that the selected algorithm is optimal for the particular trade. The meta-algorithm may use historical data collected from other executed orders that are similar to the present order and/or had the same algorithm applied thereto. That is, the meta-algorithm may analyze the performance of past orders to gauge the performance of those trades. The meta-algorithm may analyze real time performance of orders and the market in general in order to gauge if reoptimization of the order is necessary. It should be appreciated that the meta-algorithm may be unable to find an appropriate algorithm or strategy to apply to the order. In such cases, the order may be sent by the meta-algorithm to a queue for further review and possible manual execution (block 112) as shown in FIG. 1.

The meta-algorithm may have the functionality to alter a particular algorithm to fit a particular order to ensure automatic execution of the order. Therefore, if the order, on its face, would not otherwise have met the criteria for the algorithm, the meta-algorithm will implement the algorithm and actually correct for that difference within the algorithm so the order may be automatically executed. For example, the parameters of the algorithm may be altered or amended to be more aggressive to capture the alpha designated for the order, if the original algorithm was optimal for the order but has a less aggressive alpha programmed. Stated in another way, the system may have a correction mechanism. Certain criteria of an algorithm may be managed or corrected by the meta-algorithm.

A metric used by the meta-algorithm, in accordance with exemplary embodiments, may be price slippage, as described above. The price slippage is defined as the arrival price minus the execution price, measured in basis points. For example, strategy 1 could have resulted in 20 basis points of historical price slippage on average versus strategy 2, which could have resulted 30 basis points of historical price slippage on average. Therefore, the system may pick strategy 1 to apply to the order. The price slippage, for a particular strategy, may be set manually back to zero at any point by a user. Such a reset of price slippage may mean that the meta-algorithm will begin the historical assessment anew for each algorithm or strategy.

By way of a further example, an order may meet all the screening criteria except for one criterion. For instance, a rule applied to the order may require that the bid/ask spread be 50 basis points. The order has a spread greater than 50 basis points. Therefore, the order fails to meet this rule. The system will then try, through use of the meta-algorithm, to select an algorithm or algorithms in the system to allow execution of the order. The meta-algorithm may attempt to find a strategy that is designed to capture a large spread, using a historical assessment of price slippage as a metric to determine if the algorithm is optimal. For example, there may be eight different rulesets with eight different strategies. Of those eight, the meta-algorithm may determine which one has performed the best versus the arrival price for a certain period of time, as measured by price slippage. That is, the meta-algorithm may determine which of the eight strategies has the least price slippage as measured historically.

In some cases, the meta-algorithm may look at additional characteristics of the order, in addition to the failed criterion, to attempt to find an algorithm to execute the order. For example, taking the order from the preceding example with the spread greater than 50 basis points, if the order is greater than a certain size, either in dollar terms or the average daily volume over the past thirty days, then the system may send the order to a completely different strategy than selected above based on considerations for those characteristics in additional to the characteristic that caused the failure of a criterion.

Once the meta-algorithm has identified an algorithm or strategy, or multiple algorithms or strategies, to apply to the order, that algorithm or strategy may be linked to the order in the system. A determination of the order type may then be made. Further processing may occur based on this determination. In some cases, the order may proceed to directly to execution through application of the algorithm at block 114. For example, if the order is a market order, the order may be enhanced to become a limit order and the order may be appended with the order type and price.

The selected algorithms or strategies may go through a broker restriction check. This check may be followed by a broker target list check/performance ranking mechanism. This check may cause the selected algorithms or strategies to be re-weighted according to performance. Following these checks, the order may proceed for further processing at block 114 and the algorithms or strategies applied appropriately. For example, suppose there are five identified strategies: A, B, C, D, and E. Each strategy may be associated with a particular broker and may have a average historical number of basis point price slippage associated therewith. The basis points may be grouped into adjustable values of tolerance. A illustrative list follows:
A=23 basis points, broker=V;
B=88 basis points, broker=W;
C=13 basis points, broker=X;
D=10 basis points, broker=Y;
E=82 basis points, broker=Z.
   The adjustable values of tolerance may be: 0-29 basis points, 30-49 basis points, 50-79 basis points, and 80-100 basis points. The above strategies may be re-weighted as follows in the following subsets: {D, C, A} and {B, E}. Additional re-weighting may then be performed based on the performance of that broker with that strategy, on a broker level. This step may determine the most suitable broker to sent the order to for execution. This re-weighting may be determined in descending order based on the vote, i.e., how much a fund manager ideally would like to use a broker, and actual %, i.e., how much the broker actually was used. This information may be contained in a spreadsheet or other type of data structure contained in the system. Such a spreadsheet or data structure may be updated at periodic intervals The updating of the spreadsheet or data structure may be performed in real time during the execution of the order. Such updates may be performed automatically. The actual price slippage may be updated in real time, automatically, to support reweighting of the price slippage in order to reoptimize the meta-algorithm. Returning to the present example, as a result of this re-weighting, the strategies may be reordered as follows: {C, A, D}, {E, B}. Therefore, strategies C and E may be chosen between for application to the order depending upon the order.

At block 114, an algorithm may be applied to the order. The order may be executed by applying the algorithm or strategy. For example, the algorithm selected by the meta-algorithm may be applied to the order and the desired amount of stock in the order is purchased on an exchange.

At block 112, manual processing is performed on the order. The manual processing may include further processing of the order or other action by a person. The further processing may include execution of the order. In certain cases, as shown in FIG. 1, the manual processing may include modification of the order and re-entering of the order into the system for auto-routing. For example, an operator may modify the order to allow the order to meet the auto-routing criteria and re-enter the order into the system at block 104.

At block 116, the price slippage is measured. The price slippage may be measured following the order execution as described above. The price slippage may be recorded for use as the metric for application by the meta-algorithm for future orders. The price slippage may be measured at the order execution as the difference between the price at order arrival and the actual price at execution. For example, if the arrival price for the order was $10/share, but the actual price at execution was $10.05/share, the price slippage would be $0.05.

At block 118, the order is automatically executed. The order may be executed through the application of the algorithm at block 114. During the automatic execution, the order is processed and executed by an algorithm as described above. An algorithm may be determined for the order based on the characteristics of the order. A meta-algorithm may be used to determine the algorithm to apply to the order. For example, the order for the stocks may be completed. The stocks are purchased and applied to the client's account.

According to exemplary embodiments, the method 100 may have additional evaluation mechanisms to assess the order execution. For example, the order may be large. The system may take a certain amount of time to process the order. A decision made early on in the processing of the order may not be the correct decision when the order finally executes following the processing thereof. For example, an order may be entered into the system at 9 AM. The order may complete processing at 10 AM. While the decision that was made at 9 AM by the system to apply a certain algorithm to the order may have been appropriate at 9 AM based on the market conditions and other factors known to the system at 9 AM, the decision may not necessarily be the correct decision at 10 AM. The system may compensate for this by re-evaluating the decision prior to execution of the order. The system may pick then select different algorithm based on what is happening in the real-time environment and re-process the order.

Further, according to exemplary embodiments, the order may be cancelled, amended, or removed from automatic execution at any point in the process, up to the actual execution of the order. A user may enter an appropriate command into the system to perform such actions. If the user enters a command to cancel, amend, or remove the order from automatic execution, and such order fails, the user may be provided with an appropriate message indicating the reason for the failure.

FIG. 2A depicts a flow chart of a rule tree for optimizing the execution of an order according to exemplary embodiments. Exemplary flow chart 200 is provided by way of example, as there are a variety of ways to carry out the methods disclosed herein. The flow chart 200 as shown in FIG. 2A may be executed or otherwise performed by one or a combination of various systems, such as a computer implemented system according to exemplary embodiments. While the exemplary flow chart 200 may depict a particular rule structure, the depiction of this rule structure is not in any way meant to confine or restrict the invention disclosure herein, as there are an unlimited number of rule configurations that are possible.

FIG. 2A represents a tree 200 according to exemplary embodiments. The tree 200 is a set of rules and expected results. The tree 200 may be used, for example, for the automatic execution screening at block 106.

The tree 200 may have one or more nodes 202. The definition of a node 202 is a point where a rule starts. As shown in FIG. 2A, rule 1, designated by element 204, begins at node 202 at the top of the tree 200. An application of rule 1 may lead to two results, as shown in FIG. 2A: result 1, designated by element 206, or result 2, designated by element 208. The portions of the tree 200 below each node are referred to as a branch. The definition of a branch is a rule which may lead to a set of rules from any point a rule is defined, and all the results and rules below it. Result 1 may then have rule 2, designated by element 210, applied thereto, resulting in result 3, designated by element 212, and result 4, designated by element 214. Rule 2, and everything below it on tree 200, is an example of a branch of the tree 200. As shown in FIG. 2A, result 3 may have subsequent rules applied which may lead to further results. Result 4 ends in a strategy identifier 216. This is the nomenclature used for an end point of the tree 200. The strategy identifier 216 may be used to identify the particular result at that end of the tree 200.

Each of the rules contained in the tree 200 may be fully editable. It should be appreciated that the tree 200 may grow or shrink based on the deletion and addition of rules. An active tree is one that is being used for application. A shadow tree is a copy of an active tree with rules that are enabled, disabled, deleted, added and whole branches that may be copied. According to exemplary embodiments, restrictions may be imposed on the editing of rules and certain procedures may need to be followed to ensure that rule integrity is preserved and execution of orders is not impacted.

The tree 200 structure and usage will be explained by way of an illustrative example as shown in FIG. 2B. FIG. 2B depicts a sample rules structure 250. The rules structure 250 will be applied to an exemplary order for illustrative purposes. The rules structure may be applied to the order after it has been entered into the system. If the order passes all the rules, then it may proceed to automatic execution with an appropriate strategy applied thereto. Upon failing one of the rules, then the order may have the meta-algorithm applied.

The rules structure 250 may start with Rule 1, labeled as 252, which represents a node. Rule 1 may be the following rule: is the order from Group 1, 2, or 3, and alpha level greater than 1, and equity, and less than 25% Average Daily Volume (ADV). Group 1, 2, and 3 may represent three different client groups associated with and/or managed by the investment bank. These groups may be individual teams of clients. It may be desirable to construct different rules based on the group that raises the order since each group may have differing objectives. Rule 1 may have two possible results: “Yes” or “No” as shown by 254. That is, the order either meets Rule 1's criteria or it does not. Element 254 and everything below it represents a branch. If the order does not meet Rule 1, then the order will proceed down the branch to Action 1, labeled as 256. Action 1 may be placing the order into a queue for manual execution, as described above. If the order meets Rule 1's criteria, then the order will come to Rule 2, labeled as 258, which also represents a node. Rule 2 may be the following: is the order less than $500,000, and greater than 80% Best Bid & Officer (BBO) size, and less than 0.5% ADV, and BBO spread less than 30 Basis Points (BPS or bps). If the order meets the criteria of Rule 2, then the order will proceed down the “Yes” branch at 260. If the order fails to meet the criteria of Rule 2, then the order will proceed down the “No” branch at 262. On the branch 260, the order will come to Rule 3, labeled as 264. Rule 3 may ask: is the bid/ask spread less than the historical spread? If not, then Action 3A at 266 is applied. Action 3A may be a spread capture algorithm that is applied to the order. If the answer to Rule 3 is “Yes,” then Action 3B is applied at 268. Action 3B may be applying a Displaced Moving Average (DMA) or sending the order to Depository Trust Company (DTC). Returning to Rule 2, if the order fails to meet Rule 2's criteria, then the order will proceed down the branch 262. From FIG. 2B, it can be seen that branch 262 splits into a multiple sub-branches 270. The sub-branches 270 have a number of different categories extending therefrom, labeled as 272, 274, 276, 278, and 280. The order will be routed to the appropriate category based on the characteristics of the order. In this example, each category represents a % of ADV. Cat. 1 is less than 1% ADV, Cat. 2 is 1-5% ADV, Cat. 3 is 5-10% ADV, Cat. 4 is 10-15% ADV, and Cat. 4 is 15-25% ADV. For the sake of the present example, assume the order is 0.8% of the ADV. Therefore, the order will proceed to Cat. 1 at 272. The order will then be routed to an appropriate alpha category under Cat. 1. The alpha's are labeled as A1 through A4 in FIG. 2B at element 282. A1 may represent a maximum participation of 5%, A2 may represent a maximum participation of 10%, A3 may represent a maximum participation of 15%, and A4 may represent a maximum participation of 25%. As shown in FIG. 2B, block 282 may be present under each of elements 272, 274, 276, 278, and 280. For clarity, block 282 is only depicted below elements 272 and 280 in FIG. 2B. For the sake of the present example, assume the order has 5% maximum participation for alpha. The order would therefore fall within A1 for alpha. Next, as shown by 284, the order may be further routed based upon BPS. Four BPS categories may be used. BPS 1 is less than 10 bps, BPS 2 is 10-20 bps, BPS 3 is 20-40 bps, and BPS 4 is greater than 40 bps. The BPS categories of 284 may represent strategy identifiers. As can be further seen at 286, the rules applied may be structured according to risk, ranking from high risk to low risk.

FIG. 3 is a system for optimizing the execution of an order, according to an exemplary embodiment of the present invention. System 300 may provide various functionality and features associated with execution optimization. More specifically, system 300 may include a workstation 310, a second workstation 320, and an Nth workstation 330, a network 335, an algorithm module 340, a database 350, an order system 360, and other systems 370. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 300 may be integrated into and run on a computer, such as a general purpose computer which may include a processing machine which has one or more processors. Such a processing machine may execute instructions stored in a memory to process the data. System 300 may be integrated into and run on one or more computer networks which may each have one of more computers associated therewith.

As noted above, the processing machine executes the instructions that are stored in the memory or memories to process data. This processing of data may be in response to commands by a user or users of the processing machine, in response to previous processing, in response to a request by another processing machine and/or any other input, for example. As described herein, a module performing functionality may comprise a processor and vice-versa.

According to exemplary embodiments, the system 300 may be configured to carry out the method 100 as described above. The system 300 may have a workstation 310 associated therewith. A second workstation 320 and an Nth workstation 330 may be further associated with the system 300. The workstations 310, 320, and 330 may each be a processing machine, such as a general purpose computer. Each workstation 310, 320, and 330 may include software and/or modules to implement the method 100 according to exemplary embodiments. Each workstation 310, 320, and 330 may provide processing, display, storage, communications, and execution of commands in response to inputs from a user thereof and respond to requests from the software and/or modules. The workstations 310, 320, and 330 may each serve as a client side. Each workstation 310, 320, and 330 may be a fat client, such that the majority of the processing may be performed on the client. Alternatively, the workstations 310, 320, and 330 may each be a thin client, such that the majority of the processing may be performed in the other components of the system 300 as best shown in FIG. 3. The workstations 310, 320, and 330 may be configured to perform other functions and processing beyond the method 100. The workstations 310, 320, and 330 may each be a part of a larger system associated with the investment bank. That is, the workstations 310, 320, and 330 may be multi-functional in operation.

The workstations 310, 320, and 330 may be communicatively coupled to a network 335. Network 335 may be a computer based network, comprising one or more servers and/or computer processors. For example, network 335 may be the internet. Information and data may be exchanged through the network 335 between the various components of the system 300. In alternative embodiments, the network 335 may be a local area network within the investment bank. It should be appreciated that the network 335 may be a combination of local area networks, wide area networks, and external networks.

The algorithm module 340 may be communicatively coupled to the network 335. The algorithm module 340 may perform operations associated with the establishment, editing, and application of the algorithms and rulesets accordingly to exemplary embodiments. The algorithm module may execute the meta-algorithm as described above. The algorithm may measure and record the price slippage for each order. The algorithm module may consist of one or more servers and/or general purpose computers, each having one or more computer processors associated therewith.

The algorithm module 340 may have a database 350 communicatively coupled thereto. The database 350 may contain the rulesets and algorithms used by the system 300. The database 350 may store the historical data pertaining to price slippage related to each algorithm as measured by exemplary embodiments. Additional information maybe contained therein related to the operation and administration of the system 300. The database 350 may include any suitable data structure to maintain the information and allow access and retrieval of the information. For example, the database may keep the data in an organized fashion. The database 350 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 350 may be stored in any suitable storage device. The storage device may include multiple data storage devices. The multiple data storage devices may be operatively associated with the database 350. The storage may be local, remote, or a combination thereof with respect to the database. The database 350 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fibre Channel SAN, a common Internet File System (CIFS), network attached storage (NAS), or a network file system (NFS). The database may have back-up capability built-in. Communications with the database 350 may be over a network, such as the network 335, or communications may be over a direct connection between the database 350 and the algorithm module 340, as depicted in FIG. 3. Data may be transmitted and/or received from the database 350. Data transmission and receipt may utilize cabled network or telecom connections such as an Ethernet RJ45/Category 5 Ethernet connection, a fiber connection, a traditional phone wireline connection, a cable connection or other wired network connection. A wireless network may be used for the transmission and receipt of data.

An order system 360 may be associated with the system 300. The order system 360 may perform a variety of functions within the system 300. The order system 360 may consist of one or more servers and/or general purpose computers with one or more computer processors associated therewith. The workstations 310, 320, and 330 may serve as interfaces to the order system 360. The order system 360 may be the starting point for order processing. The order system 360 may provide for the execution of orders. The order system 360 may consist of one or systems that may communicate over the network 335. For example, the order system 360 may consist of two systems. Initially, an order may be received and put into a first order system. The first order system may be an auto management system. This system may provide the initial processing of the order. The first order system may be an interface to the algorithm module 340. A second order system may be an execution management system, allowing the execution and tracking of orders. The execution management system may execute the orders once the algorithm module 340 has completed its processing. The execution management system may be used for the manual execution of orders that fail the rules criteria.

The system 300 may have other systems 370 associated therewith. These other systems 370 may include various data collection and support systems used by the investment bank to carry out its functions.

Hereinafter, aspects of implementation of the inventions will be described. As described above, the method of the invention may be computer implemented as a system. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. For example, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the invention. Illustratively, the programming language used may include assembly language, Ada, APL, Basic, C, C++, C#, COBOL, dBase, Forth, Fortran, Java, Modula-2, Pascal, Prolog, REXX, Ruby, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of media or medium, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the embodiments have been particularly shown and described within the framework of execution of trades, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, uses and advantages of the present invention will be apparent to those skilled in the art from consideration of the specification and practice of the invention disclosed herein. The specification and examples should be considered exemplary. The intended scope of the invention is limited by the claims appended hereto.

What is claimed is:

1. A computer-implemented method for optimizing the automatic execution of an order for securities using a meta-algorithm comprising:
receiving, by a computer processor, an order for specified securities;
determining, by a computer processor, screening rules to apply to the order;
applying, by a computer processor, the screening rules to the order;
determining, by a computer processor, that at least one screening rule is violated;
applying, by a computer processor, a meta-algorithm to the order in response to the determination that at least one screening rule is violated;
selecting, by the meta-algorithm, an algorithm for processing the order based on the at least one violated screening rule wherein the meta-algorithm selects the algorithm based on a historical assessment of price slippage;
executing, by a computer processor, the order using the algorithm; and
recording electronically, by a computer processor, a price slippage as measured at the time of the order execution for inclusion in the historical assessment.

2. The method of claim 1, wherein the screening rules are applied to the order to determine whether the order is autoroutable.

3. The method of claim 1, wherein the specified securities comprise stocks or bonds.

4. The method of claim 1, wherein the order is received at an investment bank.

5. The method of claim 1, wherein the algorithm is configured to address a characteristic of the order causing the violation of the at least one screening rule.

6. The method of claim 1, wherein the price slippage comprises a price change measured between the order at arrival and the order at a time of order execution.

7. The method of claim 1, wherein the screening rules are pre-determined and configured prior to receiving the order.

8. The method of claim 1, wherein the algorithm selected by the meta-algorithm is optimized based on the historical assessment of price slippage such that the algorithm is selected to the reduce price slippage relative to at least a second algorithm.

9. The method of claim 1, further comprising:
receiving, by a computer processor, instructions regarding the execution of the order, wherein the instructions comprise a selection of an alpha for the order.

10. The method of claim 1, wherein the screening rules are ordered in a tree structure comprising a rule hierarchy.

11. A computer based system for optimizing the automatic execution of an order for securities using a meta-algorithm comprising:
a network comprising one or more servers;
a workstation, comprising one or more computer processors, communicatively coupled to the network, wherein the workstation provides an interface to the computer based system;
an algorithm module, comprising one or more computer processors, communicatively coupled to the network, wherein the algorithm module performs the following functions:
receiving an order for specified securities;
determining screening rules to apply to the order;
applying the screening rules to the order;
determining that at least one screening rule is violated;
applying a meta-algorithm to the order based on the determination that at least one screening rule is violated;
selecting, by the meta-algorithm, an algorithm for processing the order based on the at least one violated screening rule wherein the meta-algorithm selects the algorithm based on a historical assessment of price slippage;
recording electronically a price slippage as measured at the order execution for inclusion in the historical assessment; and
a database, communicatively coupled to the algorithm module, the database comprising the meta-algorithm and the algorithm.

12. The system of claim 11, wherein the screening rules are applied to the order to determine whether the order is autoroutable.

13. The system of claim 11, wherein the specified securities comprise stocks or bonds.

14. The system of claim 11, wherein the order is received at an investment bank.

15. The system of claim 11, wherein the algorithm is configured to address a characteristic that caused the order to violated the at least one screening rule.

16. The system of claim 11, wherein the price slippage is measured at the order execution and comprises a price change between the order at arrival and the order at execution.

17. The system of claim 11, wherein the screening rules are pre-determined and configured prior to receiving the order.

18. The system of claim 11, wherein the algorithm selected by the meta-algorithm is optimized based on the historical assessment of price slippage such that the algorithm is selected to reduce the price slippage relative to at least a second algorithm.

19. The system of claim 11, the algorithm module being further configured to:
receive instructions regarding the execution of the order, wherein the instructions comprise a selection of an alpha for the order.

20. The system of claim 11, wherein the screening rules are ordered in a tree structure comprising a rule hierarchy.
